(19) United States
(12) Patent Application Publication
(10) Pub. No.: US 2005/0283981 A1
(43) Pub. Date: Dec. 29, 2005

(54) Two directional scissors

(76) Inventor: Amiram Yizhar, Thornhill (CA)

Correspondence Address: AMIRAM YIZHAR, 56 CROWN HEIGHTS CRES., THORNHILL, ON, L4J5T4, CA

(21) Appl. No.: 11/085,687

(22) Filed: Mar. 22, 2005

(30) Foreign Application Priority Data
Jun. 25, 2004 (CA) 2,469,567

(51) Int. Cl. B26B 1/00; B25F 3/00

(52) U.S. Cl. 30/142

(57) ABSTRACT

A nail cutting device which consists essentially of two pairs of scissors connected together by a special mechanism which allows them to cut in two opposite directions, the angle between the two directions of cut can range between 180 to 90 degrees with an option to be adjusted. The device has one pair of handles and one holds and operates it in the same way one uses regular scissors. This way, one can cut one's toenails in two directions, left and right, without changing the grip on the scissors handles, using the same finger movements and avoiding any uncomfortable twisting of the hand or other part of the body.

### DESCRIPTION OF THE INVENTION

### SUMMARY

In general the two directional scissors is a combination of two pair of scissors connected together, enabling the user to cut in two directions without changing the grip on the handles.

One of the pairs which comprises of handles arms and blades will be referred to as the main pair. The other pair which includes arms and blades but not handles, will be referred to as the secondary pair

The two pairs are connected together by a special mechanism, which allows them to cut in two opposite directions; the angle between the two directions of cut can range between 180 to 90 degrees.

In the case where the two pairs are pointing exactly in opposite directions or, in other words, the angle between them is 180 degrees, the connecting mechanism that requires is different then the one requires when the angle between the directions of cuts is not exactly 180 degrees.

The drawings form a part of this specification.

In the drawings the sizes and the proportions between the various components can vary, and so the scales of the drawings.

A dotted line numbered with the prefix ‘R’ (like R1, R2 etc.) in the drawing represents an axis of rotation of a rotating object.

A dotted line numbered with the prefix ‘S’ (like S1, S2, etc. in the drawing represents a bisector of an angle.

The drawings are diagrammatic.

### DESCRIPTION OF THE DRAWINGS

FIG. 1 is a perspective view of version of the scissors where the secondary pair direction of cut is not exactly the opposite to that of the main pair, with the blades in the open position scale 2:1

FIG. 1a illustrates how to use the two directions scissors for reverse cut.

FIG. 2 is a perspective downside up view of the scissors with the blades in the open position. Scale approx 2:1.

FIG. 3 is a perspective view of the connecting mechanism between an arm of the main pair and an arm of the secondary pair turned downside up, scale 4:1

FIG. 4 is a side elevational view with blades in close position. Scale 3:2

FIG. 5 is bottom elevational view, blades closed. Scale 3:2.

FIG. 6 is bottom elevational view, blades ope. Scale 3:2.

FIG. 7 is a perspective view of a version where the secondary pair direction of cut is exactly the opposite to that of the main pair scale 2:1.

FIG. 8 is perspective view of the same version in FIG. 7 turned downside up.

FIG. 9 is a side elevational view of the version in FIG. 7.

FIG. 10 is bottom elevational view of the version in FIG. 7 blades closed.

FIG. 11 is a bottom elevational view of the version in FIG. 7 blades opened.

FIG. 12 is a perspective view of a mechanism for adjusting the angle between the first and second pairs that can be added to the scissors shown in FIGS. 1, to 6,

FIG. 13 is a bottom elevational view of the scissors with the adjustment mechanism that shown in FIG. 12.

FIG. 14 is a side elevational view of the scissors shown in FIG. 13.

FIG. 15 is an enlarged side view of the adjustment mechanism shown in FIG. 14.

FIG. 16 is sectional view taken on line 16-16, FIG. 15.

FIG. 17 is a perspective downside up view of a two directional scissors with a different connecting mechanism than the one shown in FIGS. 2 and 3.

FIG. 18 is an enlarged perspective view of the connecting mechanism shown in FIG. 17.

FIG. 19 is a side elevational view of the version in FIG. 17.

FIG. 20 is bottom elevational view of the version in FIG. 17 blades closed.

FIG. 21 is a bottom elevational view of the version in FIG. 17 blades opened.

### DETAILED DESCRIPTION OF THE INVENTION

With reference to the drawing, the two directional scissors consist of a main pair of scissors P1, and a secondary pair of scissors P2, which are connected together by a special mechanism.

Each pair comprises two arms with blades that are connected by a pivoting pin.

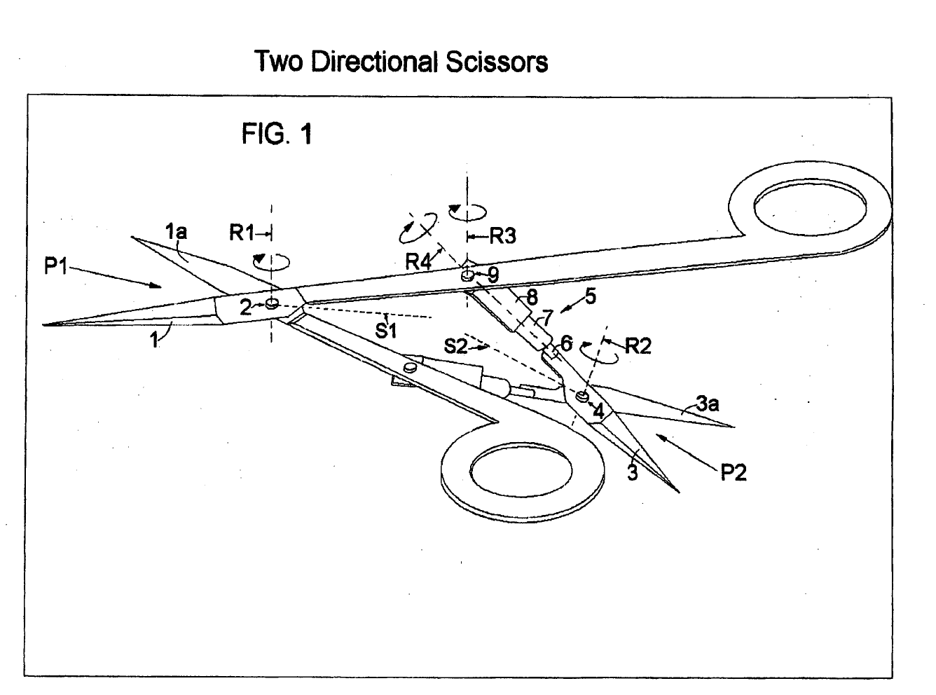

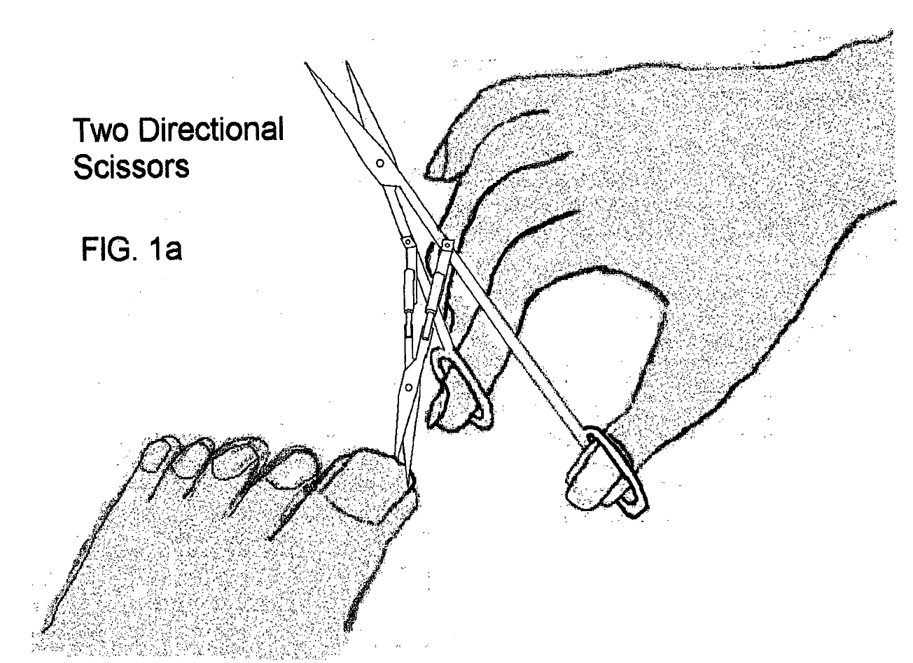

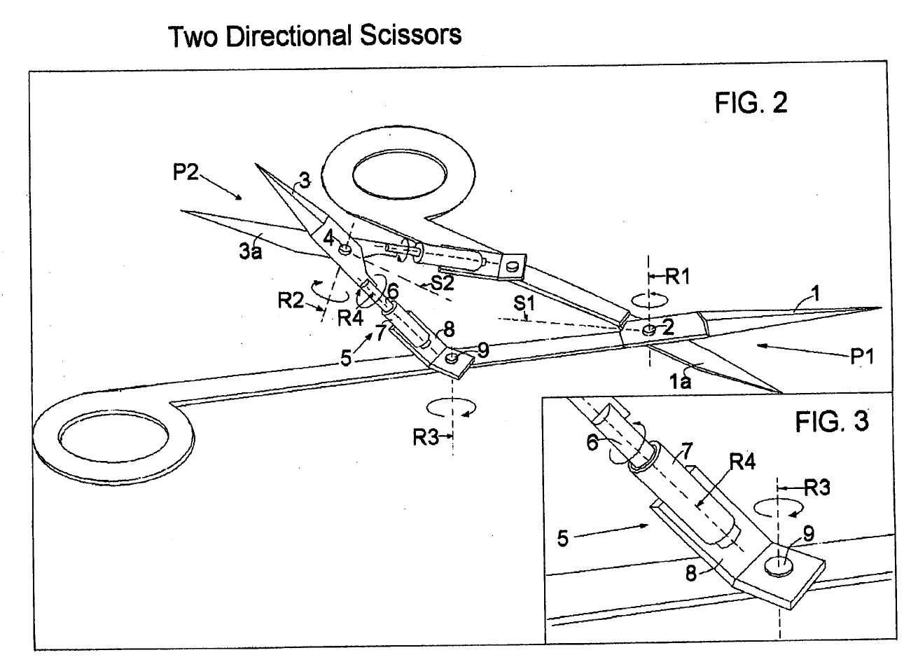

Shown in FIGS. 1, 2, 7 and 8, are the main pair blades 1, 1a, the main pair pivoting pin 2, the secondary pair blades 3, 3a, and the secondary pair pivoting pin 4.

The two way scissors can be made either with P2 and P1 are pointing to the exact opposites from each other or, the angle between the directions of the cut by P1 and P2 could be varied between 180 and 90 degrees.

The way of connecting the main pair to the secondary pair is determined by whether both P1 and P2 point to the exact opposite from each other or not.

Before continuing, the terms “direction of cut” and “exact opposite direction” has to be clarified:

While cutting, each arm of P1 performs a rotating movement around the pivoting pin 2; the rotating movement define a plane in space, the dotted line R1 shows the axis of rotation for the movement which is perpendicular to that plane. In that plane, the two arms of P1 create an angle with the pivoting pin 2 at it vertex, the dotted line S1 shows the bisector of that angle.

In the same way, R2 is the axis of rotation of the arms of P2 and S2 is the bisector of the angle they form with its vertex at 4.

The term “direction of cut” means direction along the vertex of the angle that the arms are forming, the term “exact opposite” means that S1 and S2 are parallel to each other, and also R1 and R2 are parallel to each other, the term “angle between the direction of cuts” means the angle between S1 and S2 when they are in the same plane, or the angle between the two planes created by the movements of the arms of P1 and P2. When the two pairs points to the exact opposites, the angle between the directions of cuts is exactly 180 degrees.

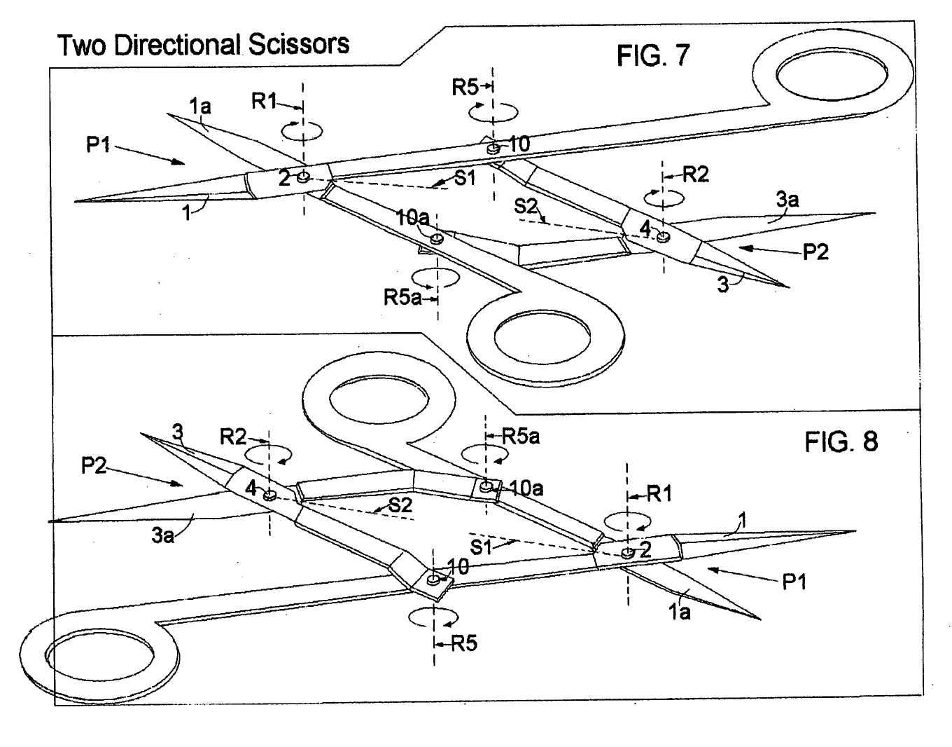

In the case is where P1 and P2 point to the exact opposites as seen in FIGS. 7 to 11, each arm of the secondary pair is connected to an arm of the main pair by one pivoting pin 10 and 10a with axes of rotation R5 and R5a. In that case R1, R2, R5 and R5a are all parallel to each other.

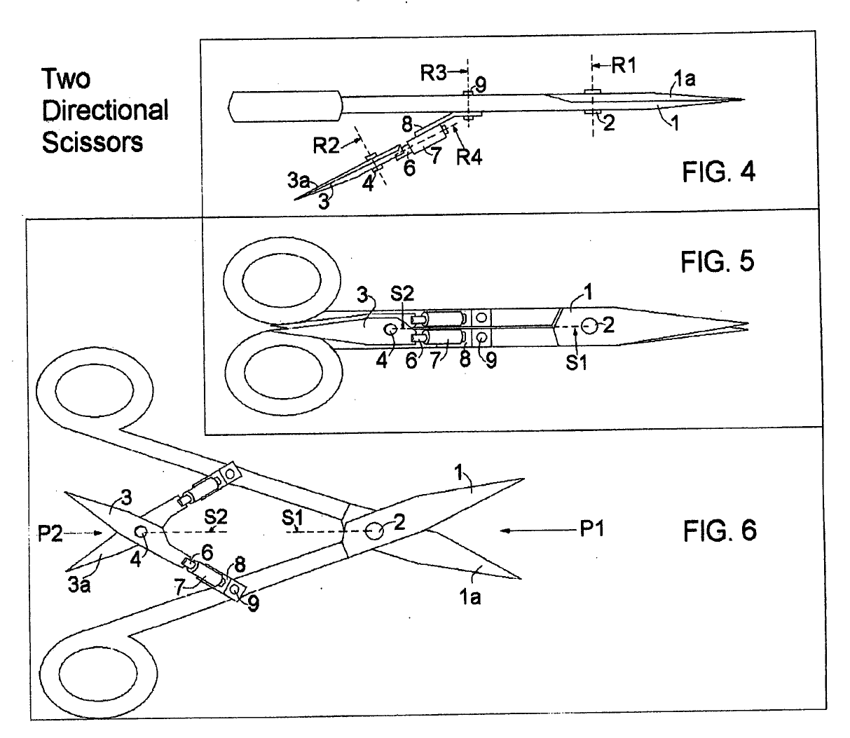

The other case where the angle between the direction of cut of P1 and P2 is less then 180 degrees and greater then 90 degrees is shown in FIGS. 1 to 6. In that case, each connecting mechanism between the arms of the main pair the secondary pair, have to allow both arms a free rotation along two different axes in space relative to each other, these axes are shown as R3 and R4 in FIGS. 1, 2, 3, 4.

That ability to rotate freely along two different axes in space enables both pairs to perform a smooth cutting movement in the case where P1 and P2 do not point to the exact opposites.

The connecting mechanism between the arms of the main pair and the secondary pair where P1 and P2 do not point to the exact opposites is numbered 5 in FIGS. 1 to 6.

As best seen in FIG. 3, each connecting mechanism comprises a pivoting frame 8, a pivot pin 9, a rotating axle 6, and an axle support 7.

Each pivoting frame is connected to one arm of the main pair by pivot pin 9, which allows free rotation of the pivoting frame relative to the arm of the main pair, with R3 as the axis of rotation.

The axle support 7 is fixed to the pivoting frame 8. The axle support has the shape of a tube which allows free rotation of the rotating axle 6 relative to the pivoting frame, With R4 as the axis rotation.

Each of the blades of the secondary pair 3 is fixed to one of the rotating axles. As seen in FIGS. 1 to 3, the rotating connections mechanism allows the arm of the secondary pair a free rotation along two axes in space relative to the arm of the main pair, one is R3, the axis of rotation at the pivoting frame 8 and the other axis is R4, the axis of the rotating axle 6.

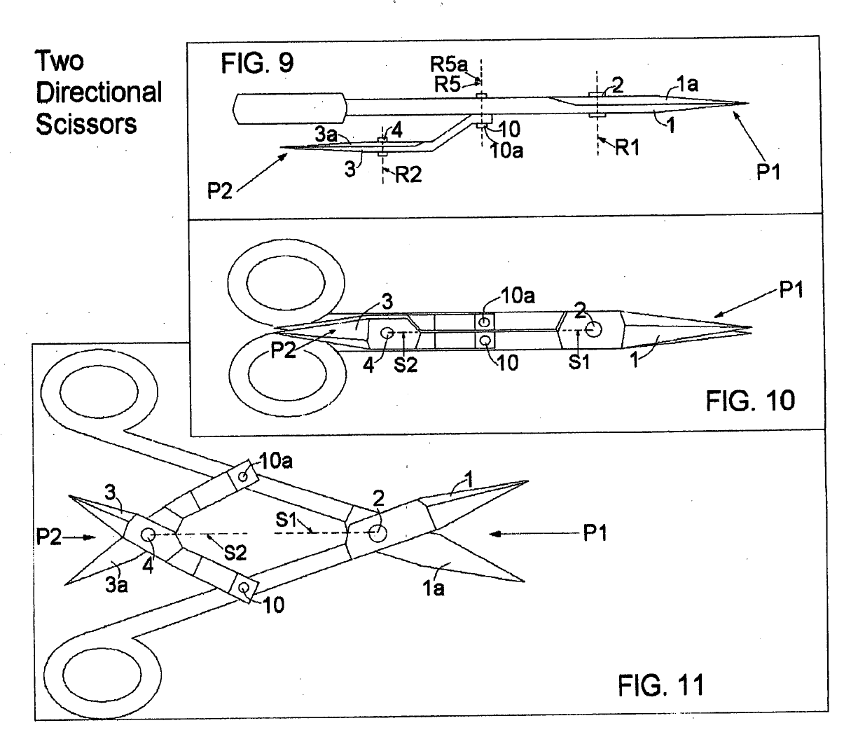

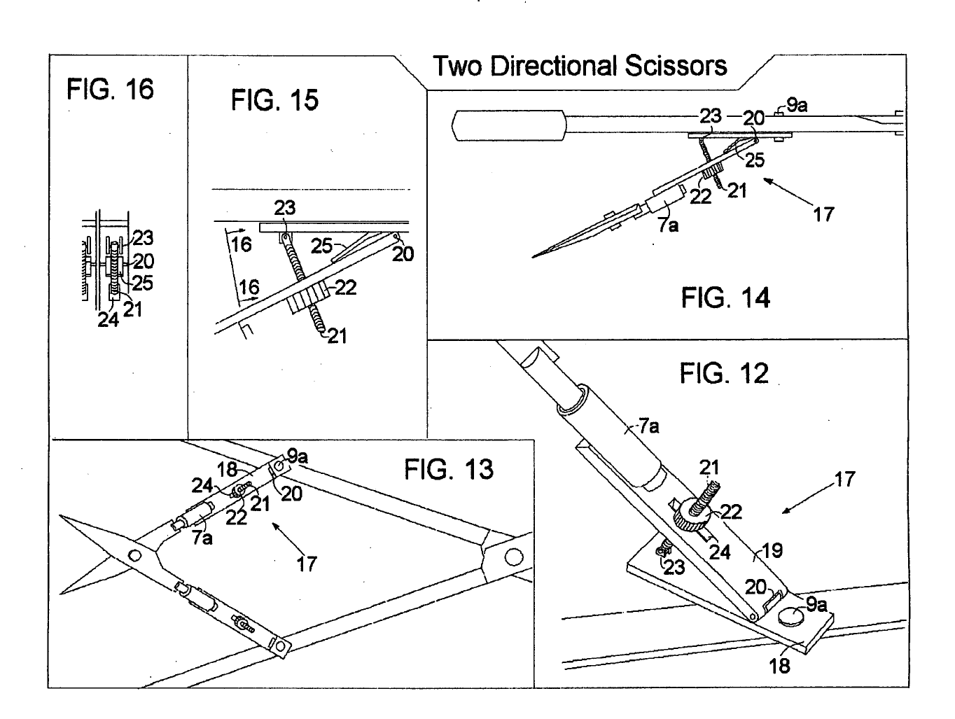

FIGS. 12 to 16 are showing another mechanism that can be added to the two directional scissors to enable manual adjustment of the angle between the two pairs shown in FIGS. 1 to 6 and is referred to as the adjustment mechanism. It is numbered 17 in FIGS. 12 to 16, and can replace the pivoting frame 8 shown in FIGS. 1 to 7.

The adjustment mechanism 17 comprises a pivoting plate 18 connected to another plate 19 by a hinge 20, a spring 25 that pushes the plates away from each other towards wider angle, a screw 21 that connected in one side to plate 18 by a pivoting pin 23, and the other side go through a rectangle slot 24 in the plate 19, and a round nut 22 for adjusting the opening angle between plates 18 and 19.

The adjustment mechanism is connected on one side to the arm of the main pair via pivoting pin 9a and on the other side plate 19 is connected to the axle support 7a. By rotating the nut 22 the user can adjust the angle between the main pair and the secondary pair.

It will be apparent that some changes and modifications can be made without departing from the scope of the invention defined in the claims. Thus, the connecting mechanism can be replaced by an alternate one, as long as it allows both arms connected a free rotation along two different axes in space.

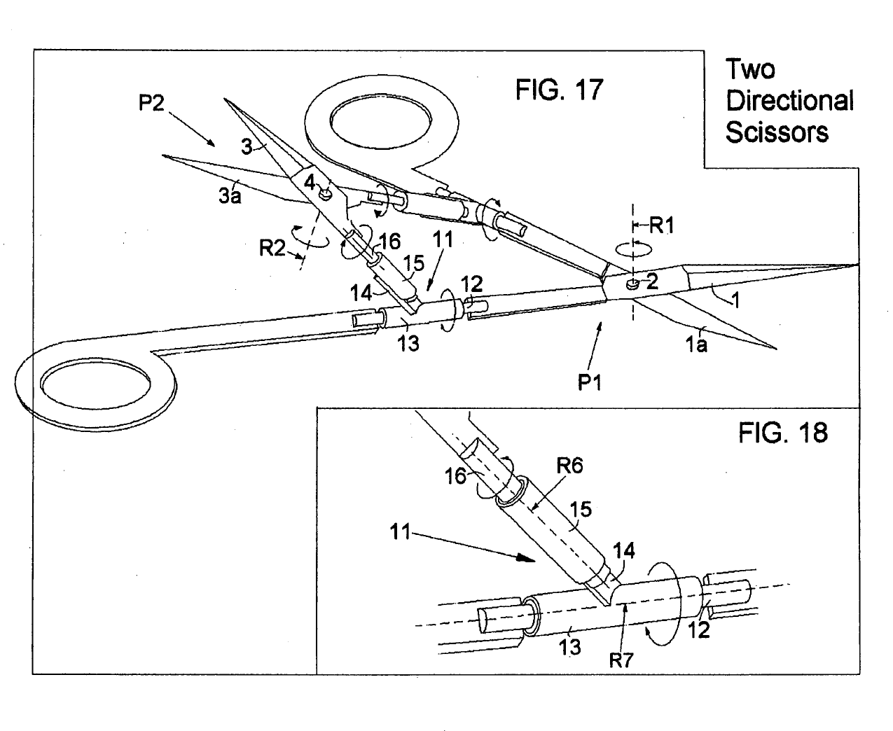

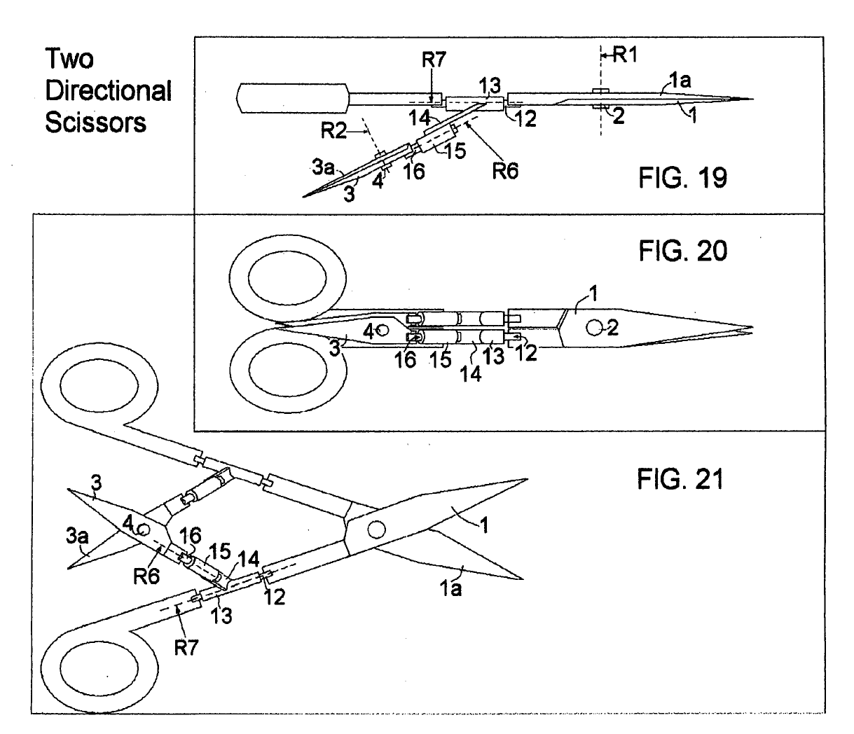

FIGS. 17, 18, show alternative structure to the connecting mechanism that is different from the one seen in FIGS. 1 to 6.

As best seen in. FIG. 13 the alternative connecting mechanism which is numbered 11, it comprises a rotating axle 12 fixed in both sides to the arm of the main pair, an axle support 13 in a shape of a tube another axle support 15 in a shape of a tube, a support base 14 that is connected to both axle supports 13 and 15, and another rotating axle 16, which is fixed to one of the blades of the secondary pair.

This structure allows the arms of both pairs a free rotation along two axes of rotation in space, R6 and R7.

Also, the size of the components the proportions between the size of the components, and the angle between the main pair and the secondary pair, can be changed without departing from the scope of the invention defined in the claims.

One holds and operates the scissors by the handles of the main pair, in the same manner as one would operate regular scissors.

1. A combination of one regular pair of nail scissors and an extra Lair of scissors blades connected to it and points to the opposite direction, each arm of one pair is connected to an arm of the other pair by a special mechanism which allows both pairs to cut in the opposite directions while operating by one pair of handles like a regular pair of scissors and using the same finger movements for cutting in both directions.

2. The combination defined in claim 1 wherein one pair direction of cut is exactly opposite to the direction of cut of the other pair.

3. The combination defined in claim 1, wherein the angle formed between the two pairs direction of cut is less then 180 degrees and greater then 90 degrees.

4. The combination defined in claim 2, wherein each arm of the extra pair connected to an arm of the first pair by one rotating component, a pivoting pin or axle.

5. The combination defined in claim 3, wherein each arm of the extra pair connected to an arm of the first pair by a connecting mechanism which enables both pairs to perform cut movement while the angle between their direction of cut is less then 180 degrees, by allowing each arm of the extra pair free rotation along two axes in space relative to the arm of the first pair to which it is connected to.

6. The combination defined in claim 3, wherein the connection between the arms of the two pairs includes a mechanism that enables manual adjustment of the angle between the directions of cut of the two pairs.
